(19) United States
(12) Patent Application Publication
(10) Pub. No.: US 2008/0056403 A1
(43) Pub. Date: Mar. 6, 2008

(54) METHOD AND APPARATUS FOR TIMING RECOVERY OF PAM SIGNALS

(75) Inventor: Tom Wilson, Vienna (AT)

Correspondence Address: SCHNECK & SCHNECK, P.O. BOX 2-E, SAN JOSE, CA, 95109-0005, US

(73) Assignee: ON DEMAND MICROELECTRONICS, Vienna (UT)

(21) Appl. No.: 11/841,430

(22) Filed: Aug. 20, 2007

Related U.S. Application Data
(60) Provisional application No. 60/824,306, filed on Sep. 1, 2006.

(51) Int. Cl. H04L 27/02

(52) U.S. Cl. 375/268

(57) ABSTRACT

A timing recovery method is presented which enables time recovery of multi-level PAM signals at baud rate. The method uses a fixed A/D clock, a digital interpolator to re-synchronize incoming samples; a timing phase detector; a loop filter and a numerically controlled oscillator (NCO), controlling re-synchronization of incoming samples within the interpolator. The usage of a Farrow interpolator and a multi-level PAM timing phase detector allows a reduced complexity of the time recovery circuit and a free running clock to the A/D converter.

### CROSS-REFERENCE TO RELATED APPLICATION

This application claims priority from U.S. provisional application No. 60/824,306; filed Sep. 1, 2006.

### TECHNICAL FIELD

This disclosure relates to communication techniques where it is desired to align receiver samples to a transmitted signal in the absence of a common clock.

### BACKGROUND

Timing recovery is one of the most important functions in a digital communications receiver and has to compensate for the timing impairments which are timing phase error, symbol rate mismatch and random jitter: the timing recovery function has to choose an optimal sampling phase for the analog-to-digital (A/D) converter, it should track the random timing jitter (or at least its low frequency components), and it should estimate and track the symbol rate mismatch of the received signal.

The structure of implementations of the timing recovery function usually resembles a classical phase locked loop (PLL). A straightforward implementation modifies the clock signal that controls the A/D (e.g. by using a voltage controlled oscillator) and is shown in FIG. 1. The structure consists of three main functional blocks. One block is a timing phase detector 102 that measures the timing error of the signal. The next block is a loop filter 103, that smoothes this measurement. The third block is a voltage-controlled oscillator (VCO) 104 that varies its output frequency according to the correction signal received from the loop filter 103. The output of the VCO 104 is used to clock the A/D 101. However, this structure is an expensive solution, as it requires a more accurate A/D with a lower error tolerance, i.e., a high specification A/D. Hence, it is usually preferred that the A/D 101 will sample with a free-running clock and the timing modifications will be done by digital interpolation of the A/D output samples, as shown in FIG. 2.

FIG. 2 shows a classical timing recovery function implementation 200 that employs digital interpolation of A/D output samples. The A/D 201 runs with a free running clock at baud rate (or above baud rate). The baud rate (data symbol rate) is the minimum at which the information within the signal may be recovered (under the Nyquist criterion), and therefore the theoretical (and practical) lowest at which the system may receive an input stream. The analog VCO 104 of FIG. 1 is replaced by a digital NCO (numerically controlled oscillator) 205 in FIG. 2 that calculates the required sampling instances. The interpolator 202 uses these values to modify the data samples as if they were originally sampled at the required instances. Possible interpolation methods can be, but are not limited to, polynomial interpolation (e.g. linear or cubic) or others (e.g. piecewise parabolic).

A compromise solution for baud rate sampling systems, commonly used in Gigabit Ethernet transceivers, is to again vary the clock for the A/D 301 with a clock generator 306 as shown in FIG. 3. However, the clock generator 306 employs an oscillator, which generates several free running clock signals. The clock signals have the same frequency and, however, different timing phases. The clock frequency corresponds to the baud rate. The timing phases are equally spaced and are constant. For example, if 4 clock signals are generated, each clock signal has a constant timing phase offset to the next signal of ¼ times the clock period of the clock signal. The timing recovery loop uses an NCO as shown in FIG. 3 and its quantized value simply chooses the most appropriate clock phase. This solution has two main drawbacks, compared with the analog VCO solution: the timing phase adaptation is limited to a discrete number of possible clock phases, which results in a residual timing error. Also, switching from one clock phase to another generates a discontinuity in timing phase. These drawbacks dictate the required number of phases. Regarding Gigabit Ethernet, for example, 64-128 clock phases are required for adequate performance. Regardless, this solution is much cheaper and simpler to implement than the analog VCO, and it can be easily integrated to system-on-a-chip silicon devices.

Another invention given by Sommer and Zion (U.S. Patent Application Publication No. 2005/0232383, “Timing Recovery of PAM Signals using Baud Rate Interpolation”) makes use of the implementation shown in FIG. 2 and FIG. 3. It incorporates a baud-rate interpolator, which is an adaptive linear filter whereas its taps are adapted with an LMS algorithm. The disadvantage of this method is that the filter coefficients continuously have to be adopted.

In the field of multi-level PAM (number of levels is greater than 2) signal reception, no published solution yet provides a robust, efficient implementation capable of operating at baud rate in a non-‘data-aided’ mode.

### SUMMARY

Briefly, in accordance with the present disclosure, there is provided a new and improved method and apparatus that can enable timing recovery of multi-level PAM signals at baud rate. The method uses a free-running A/D clock, a continuously variable digital delay (CVDD) as digital interpolator to re-synchronize incoming samples; a timing phase detector; a loop filter and an NCO, controlling re-synchronization of incoming samples within the interpolator. The usage of a baud rate CVDD interpolator and a baud rate multi-level PAM timing phase detector permits a reduced-complexity baud rate timing recovery system, employing an A/D converter operating from a free running clock.

### BRIEF DESCRIPTION OF THE DRAWINGS

In the following the disclosure is explained in further detail with the use of preferred embodiments, which shall not limit the scope of the disclosure.

FIG. 1 illustrates a classical implementation of a timing recovery function that employs direct A/D clock control.

FIG. 2 illustrates a classical implementation of a timing recovery function that employs digital interpolation of A/D output samples.

FIG. 3 illustrates a classical implementation of a timing recovery function that employs digital interpolation of A/D output samples and uses a simple clock generator.

FIG. 4 shows in simplified form an embodiment of an implementation of the time recovery function according to the disclosure. The drawing illustrates an exemplary embodiment of the disclosure and must not be considered as limiting its scope.

FIG. 5 shows a timing phase detector that is operated at baud rate.

FIG. 6 shows an example of a Farrow interpolator.

FIG. 7 shows an example of a finite impulse response (FIR) filter.

FIG. 8 shows another embodiment of the disclosure, which uses a decision feedback equalizer (DFE).

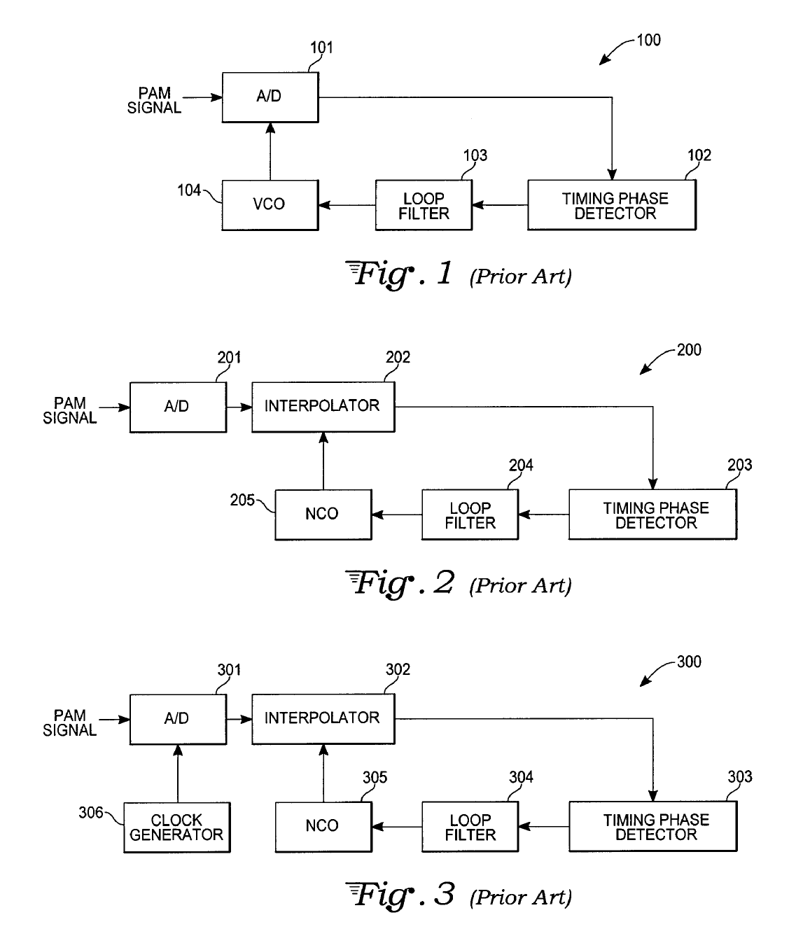

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In one embodiment, a timing recovery method which enables time recovery of multi-level PAM signals at baud rate is disclosed which can use a fixed free running A/D clock, a digital interpolator to re-synchronize incoming samples; a timing phase detector; a loop filter and a numerically controlled oscillator (NCO), controlling re-synchronization of incoming samples within the interpolator. For the interpolator a continuously variable digital delay (CVDD) can be used with a multi-level PAM timing phase detector, which allows the whole time recovery circuit to run at baud rate.

There are various definitions for “baud rate” known in the art. The transmitter baud rate is the clock the timing recovery system tries to reconstruct. In this disclosure, the A/D baud rate is a coarse approximation of the transmitter baud rate and the reconstructed baud rate is the estimate of the transmitter baud rate as derived by the timing recovery system.

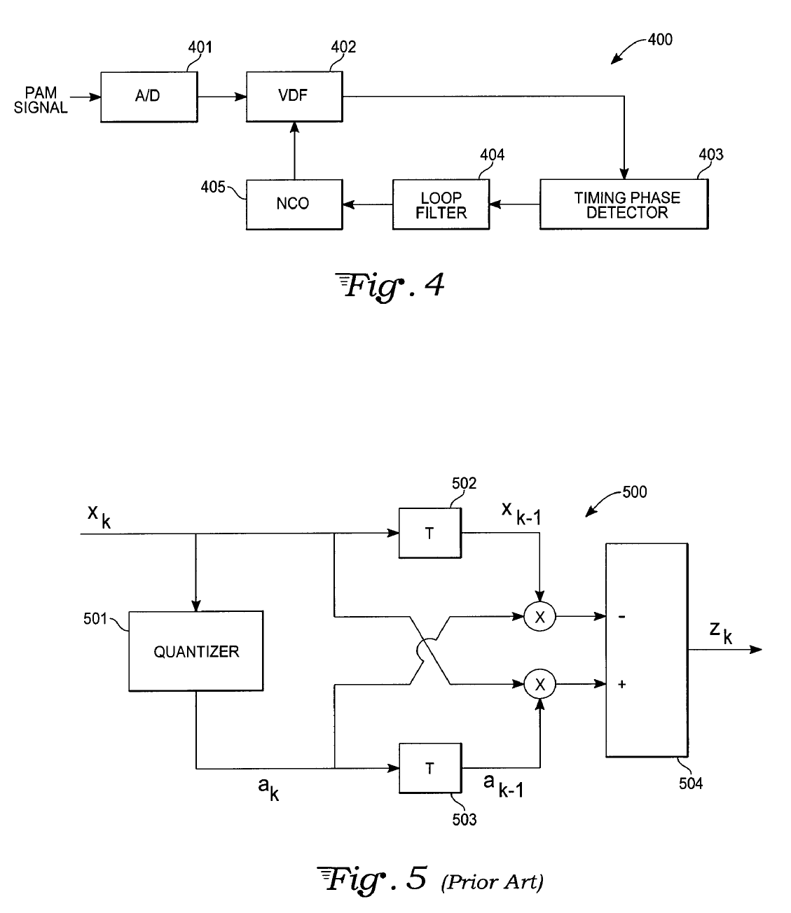

The present disclosure is depicted in FIG. 4. For the interpolator 402 a Farrow interpolator has been chosen. The precise description of the Farrow interpolator is given in Erup et.al. (“Interpolation in digital modems—Part II: Implementation and performance”, IEEE Trans. Comm. Vol. 41, pp. 998-1008 (1993)) and by Farrow (“A continuously variable digital delay element,” Proc. IEEE Int. Symp. Circuits & Syst., pp. 2641-2645, (1988)). Erup et.al. give examples of the interpolator at two times baud rate. However, albeit of his description, it should be noted, that the Farrow interpolator 402 can even be used at baud rate, which is of importance for the present disclosure. A Farrow Interpolator, operating at baud rate is in fact a so-called continuously variable digital delay (CVDD), where the fractional delays between input and output samples are controlled by an input fractional delay value to the CVDD. Thus, resampling is achieved if the fractional delay value is incremented between subsequent input samples. Two or more input samples at baud rate are used in the computation of each output sample, depending on the interpolation technique chosen. Other advantages of this interpolator are that it is an efficient method and apparatus of resampling, whether implemented in hardware or software.

Continuity of the signal at the output of the CVDD 402 in the case of over- or under-flows of the fractional delay value to the CVDD 402 outside of the 1→0 region is maintained by an elastic buffer at the input to the interpolator. Byrne and Conway (U.S. Pat. No. 6,487,672, “Digital timing recovery using baud rate sampling”) use a similar elastic buffer for their output buffer. In response to detection that the fractional delay value has wrapped past its maximum value through its minimum value, the elastic buffer prevents one input sample value from being fed to the input of the CVDD 402; and in response to detection that the fractional delay value has wrapped past its minimum value through its maximum value, the elastic buffer stores one associated input sample value, and thereby effectively passes it twice to the CVDD 402.

The timing phase detector 403 can be a multi-level PAM, non-data-aided timing phase detector and is depicted by 500 in FIG. 5. Operating at baud rate, the timing phase detector 500 is of the type described by Mueller and Müller. The timing phase error zₖ is determined by the following equation whereas xₖ is the current input sample, xₖ₋₁ is the previous input sample, aₖ is the quantized current sample of xₖ and is the result of the quantizer 501, and aₖ₋₁ is the previous quantized sample. The T-blocks 502 and 503 act as buffers that hold the previous values. Quantizing means rounding to the nearest allowed symbol level (e.g. 1 or −1 for binary transmission). The value b is a design parameter, i.e., it can be set to a level suited to the application (by an engineer).

zₖ=b(x_{i a}ₖ₋₁−xₖ₋₁aₖ)

If the channel impulse response is expected to significantly degrade the received signal, the timing phase detector 500 could be extended to a more complex structure to provide additional robustness. An advantage of the timing phase detector 500 is that it is a simple algorithm, lending itself to a lean and efficient implementation.

For the loop filter 404, e.g., a second order loop filter could be used which results in a zero steady state phase error and phase ramp error if the DC gain of the loop filter is infinite.

Using the present approach and apparatus, a free running clock can be applied to the A/D 401 whereas all components (the CVDD 402, the timing phase detector 403, the loop filter 404, and the NCO 405) run at baud rate.

In a timing recovery system, the A/D typically occupies a significant proportion of the silicon area. As this solution operates at baud rate, the A/D size may be kept to a minimum, thus reducing the silicon area and associated power requirements. Moreover, the data throughput (in the digital domain) is at baud rate, minimizing constraints on data buses. As all of the computation within the timing recovery system is performed at baud rate the processing requirements are minimized (with beneficial implications on clock rate and power). In addition, this reduces the data rate and associated computation within any baud-rate subsystems (e.g. channel equalizer) that precede the timing detector.

The disclosure is ‘non data-aided’, i.e., it can operate continuously and maintain fine timing tracking without being restricted to periodically transmitted known data (training) signals. This yields superior Bit Error Rate (BER) performance.

The disclosure is a multi-level PAM solution. Many similar but inferior methods are restricted to using binary signals, restricting the scope of applications and/or the proportion of time for which the timing recovery system can be active, thereby impairing tracking performance.

FIG. 6 shows an example of a Farrow interpolator 600. The input to the CVDD is a stream of digital samples x(m), which are processed by the structure so as to produce output data samples y(k). The parameter g(k) indicates the fractional delay that will be applied to the current input sample. If t(k) is constant, the effect of the CVDD is to apply the same fractional delay to all samples. If it increases over successive samples, the output is downsampled relative to the input. If it decreases, the output is upsampled. If it is used for resampling (either up or down), the index m must be appropriately adjusted every time the parameter μ crosses a 0.0 or 1.0 boundary, as μ is normally restricted to the range 0.0 to 1.0.

The “Order” of a Farrow interpolator having N+1 columns is N. In the case of FIG. 6 there are 4 columns, so it is a (4-1)=3rd Order structure. A higher Order is normally associated with superior performance.

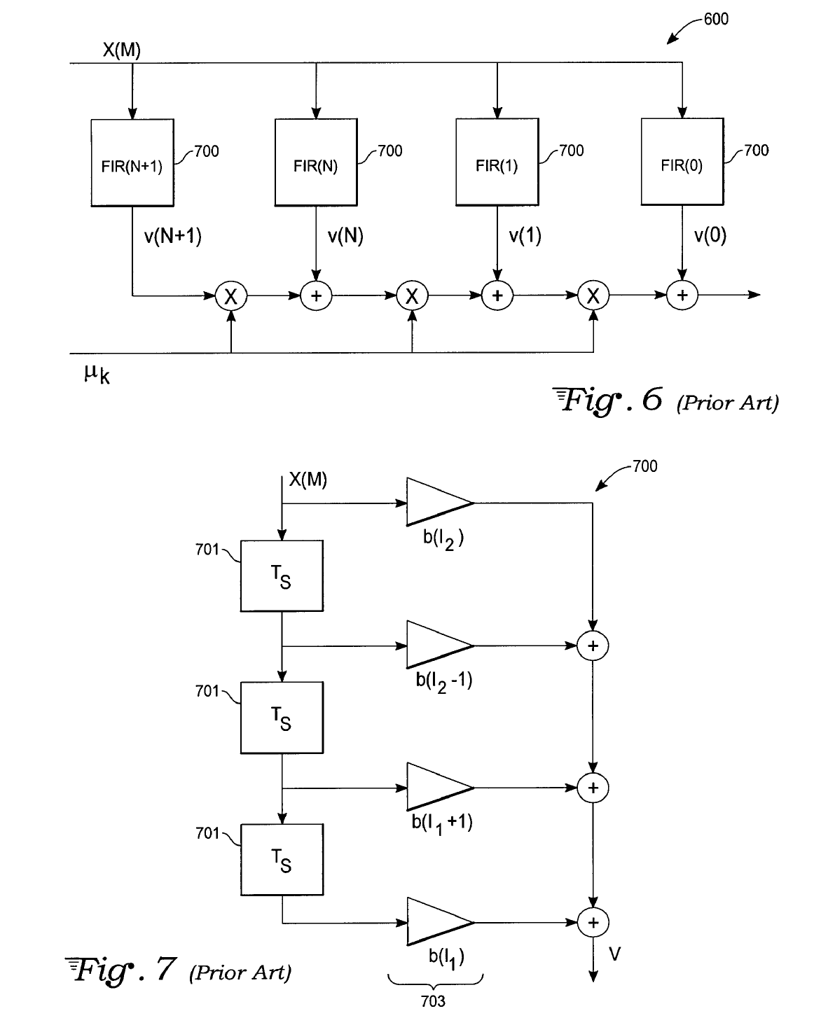

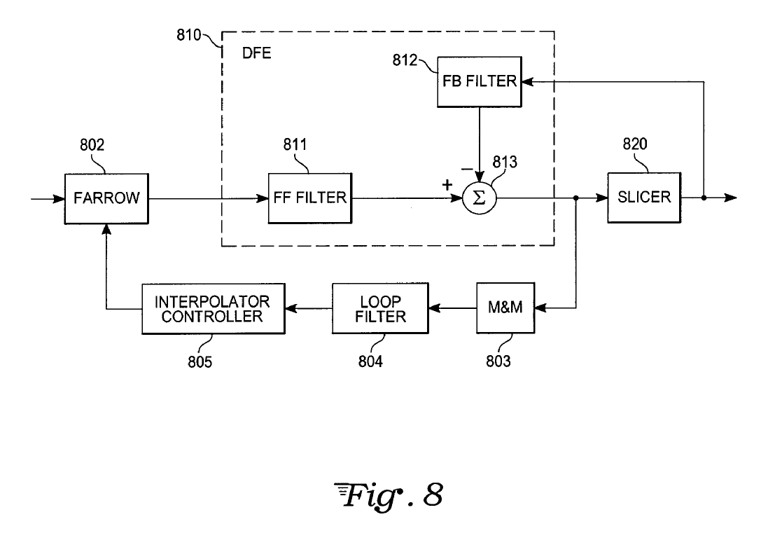

Each column consists of I coefficients in a finite impulse response (FIR) filter 700. The coefficient values are static (i.e. do not change over time). Each FIR filter (column) must have the same number of coefficients: a larger number is normally associated with superior performance. Such a FIR filter 700 is shown in FIG. 7 for I=4. The sample v is calculated from the input samples x(m) and previous input samples that are delayed by the period Tₛ. The sample v is a sum of weighted input samples whereas the weights (the coefficients b(0) to b(3)) 703 can be constant.

FIG. 8 shows another embodiment of the disclosure that uses a decision feedback equalizer (DFE) 810. The Farrow interpolator 802 receives the input samples and can be controlled by a fractional delay. The timing phase detector 803 can be a multi-level PAM, non-data-aided timing phase detector of Mueller and Müller (“Timing Recovery in Digital Synchronous Data Receivers,” IEEE Transactions on Communications, Vol. Com-24, No. 5, pp. 516-531 (1976)), as described by 500 in FIG. 5. The DFE 810 can use an FF-Filter (feed forward filter) 811 and FB-Filter (feedback filter) 812 to remove multi-path distortions of the incoming signal. Both filters 811 and 812 can be FIR-filters. A slicer 820 can be used to quantize the output signal of the DEF 810.

As another example application the described embodiments can be used in the demodulator within an ATSC (American digital TV) receiver, or for xDSL modems. The input to the interpolator does not necessarily have to be at (approx.) baud rate: it could be 1.5× or 2×baud rate, for example. In this case, the interpolator can be used to simultaneously convert from one sample rate to another, while performing timing synchronization.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Samples and/or data can be retrieved from an electronic storage medium. The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can automatically tune a transmission line. It is understood that the form of the arrangements shown and described in the detailed description and the drawings are to be taken merely as examples. It is intended that the following claims be interpreted broadly to embrace all the variations of the example embodiments disclosed.

What is claimed is:

1. A method of signal timing recovery, the method comprising the steps of:
applying a free running clock at baud rate (or above baud rate) to the A/D;
sampling a pulse amplitude modulation (PAM) signal at baud rate;
measuring a timing error associated with the sampled PAM signal at baud rate (or above baud rate);
smoothing the timing error measurement;
calculating a control signal in response to the timing error measurement; and
interpolating the sampled PAM signal at a rate dependent on the control signal.

2. The method according to claim 1, wherein said step of interpolating comprises filtering each selected sample via a continuously variable digital delay.

3. The method according to claim 2, wherein said step of interpolating is implemented as a Farrow interpolator.

4. The method according to claim 3, wherein said method of measuring the timing error is implemented as a baud rate timing phase detector which is calculated from the difference of the current input sample multiplied by the previous quantized sample and the previous input sample multiplied by the quantized current sample.

5. The method according to claim 3, wherein said step of interpolating comprises the step of parabolic, cubic or higher order filtering of the interpolated signal.

6. The method according to claim 3, wherein said step of interpolating allows reconstruction of multi-level PAM signals.

7. A signal timing recovery system comprising:
an analog to digital converter (A/D) operational to sample a pulse amplitude modulation (PAM) signal at baud rate (or above baud rate);
a timing phase detector operational to measure a residual timing error associated with the sampled PAM signal at baud rate;
a loop filter operational to smooth the residual timing error measurement; a numerically controlled oscillator (NCO) operational to calculate a required sampling instance in response to the smoothed residual timing error measurement; and
a continuously variable digital delay operational in response to the NCO to shift the sampled PAM signal from one timing phase to another and to reconstruct the PAM signal there from.

8. The signal timing recovery system according to claim 7, wherein said continuously variable digital delay is operated at baud rate.

9. The signal timing recovery system according to claim 8, wherein said continuously variable digital delay is implemented as a Farrow interpolator.

10. The signal timing recovery system according to claim 9, wherein said timing phase detector is implemented using the difference of the current input sample multiplied by the previous quantized sample and the previous input sample multiplied by the quantized current sample.

11. A signal timing recovery system comprising:
sampling means for converting a pulse amplitude modulation (PAM) signal at baud rate (or above baud rate) to a digital signal;
means for measuring a residual timing error associated with the sampled PAM signal at baud rate;
means for smoothing the residual timing error measurement;
means for calculating a required sampling instance in response to the smoothed residual timing error measurement and for generating a fractional delay value by which to shift the sampled PAM signal; and
said means for shifting the sampled PAM signal from one timing phase to another in response to said fractional delay value received from said means for calculating a required sampling instance and for reconstructing the PAM signal there from.

12. The signal timing recovery system according to claim 11, wherein said sampling means comprises an analog to digital converter.

13. The signal timing recovery system according to claim 12, wherein the means for measuring a residual timing error comprises a timing phase detector operated at baud rate.

14. The signal timing recovery system according to claim 13, wherein the means for smoothing the residual timing error measurement comprises a loop filter.

15. The signal timing recovery system according to claim 14, wherein the means for calculating a required sampling instance in response to the smoothed residual timing error measurement comprises a numerically controlled oscillator which generates a fractional delay value for said means for shifting the PAM signal.

16. The signal timing recovery system according to claim 15, wherein the means for shifting the sampled PAM signal from one timing phase to another in response to a fractional delay value received from said means for calculating a required sampling instance and for reconstructing the PAM signal there from comprises a continuously variable digital delay.

17. The signal timing recovery system according to claim 16, wherein the continuously variable digital delay comprises a Farrow interpolator.
